(19) United States
(12) Patent Application Publication
(10) Pub. No.: US 2015/0144522 A1
(43) Pub. Date: May 28, 2015

(54) NUCLEATION AND DESTABILIZATION OF LIQUIDS ON LIQUID-IMPREGNATED SURFACES

(71) Applicant: LiquiGlide Inc., BOSTON, MA (US)

(72) Inventors: Charles HIBBEN, Darien, CT (US); J. David SMITH, Cambridge, MA (US); Kripa K. VARANASI, Lexington, MA (US)

(21) Appl. No.: 14/552,778

(22) Filed: Nov. 25, 2014

Related U.S. Application Data
(60) Provisional application No. 61/908,493, filed on Nov. 25, 2013.

(51) Int. Cl. B65D 25/14; B08B 17/06

(52) U.S. Cl. CPC B65D 25/14; B08B 17/065
USPC 206/524.3; 29/428

(57) ABSTRACT

A container for housing a contact liquid includes a liquid-impregnated surface in contact with a contact liquid. The liquid-impregnated surface includes a first surface having a first roll off angle. A plurality of solid features are disposed on the first surface, such that a plurality of interstitial regions are defined between the plurality of solid features. An impregnating liquid is disposed in the interstitial regions and the interstitial regions are configured such that that the impregnating liquid is retained in the interstitial regions by capillary forces. The impregnating liquid disposed in the interstitial regions defines a second surface having a second roll off angle less than the first roll off angle. The container further includes a nucleation mechanism configured to nucleate and destabilize a film of the contact liquid disposed on the liquid-impregnated surface, such that the film of the contact liquid can be rapidly removed from the container.

### CROSS-REFERENCE TO RELATED APPLICATION

This application claims priority to U.S. Provisional Application No. 61/908,493, entitled “Nucleation and Destabilization of Liquids on Liquid-Impregnated Surfaces,” filed Nov. 25, 2013, the disclosure of which is incorporated herein by reference in its entirety.

### BACKGROUND

The advent of micro/nano-engineered surfaces in the last decade has opened up new techniques for enhancing a wide variety of physical phenomena in thermofluids sciences. For example, the use of micro/nano surface textures has provided non-wetting surfaces capable of achieving less viscous drag, reduced adhesion to ice and other materials, self-cleaning, anti-fogging capability, and water repellency. These improvements result generally from diminished contact (i.e., less wetting) between the solid surfaces and adjacent liquids.

One type of non-wetting surface of interest is a super hydrophobic surface. In general, a super hydrophobic surface includes micro/nano-scale roughness on an intrinsically hydrophobic surface, such as a hydrophobic coating. Super hydrophobic surfaces resist contact with water by virtue of an air-water interface within the micro/nano surface textures.

One of the drawbacks of existing non-wetting surfaces (e.g., superhydrophobic, superoleophobic, and supermetallophobic surfaces) is that they are susceptible to impalement, which destroys the non-wetting capabilities of the surface. Impalement occurs when an impinging liquid (e.g., a liquid droplet or liquid stream) displaces the air entrained within the surface textures. Previous efforts to prevent impalement have focused on reducing surface texture dimensions from micro-scale to nano-scale.

Another drawback with existing non-wetting surfaces is that they are susceptible to ice formation and adhesion. For example, when frost forms on existing super hydrophobic surfaces, the surfaces become hydrophilic. Under freezing conditions, water droplets can stick to the surface, and ice may accumulate. Removal of the ice can be difficult because the ice may interlock with the textures of the surface. Similarly, when these surfaces are exposed to solutions saturated with salts, for example as in desalination or oil and gas applications, scale builds on surfaces and results in loss of functionality. Similar limitations of existing non-wetting surfaces include problems with hydrate formation, and formation of other organic or inorganic deposits on the surfaces.

Thus there is a need for improved non-wetting surfaces that have enhanced durability and life expectancy.

### SUMMARY

Embodiments described herein relate generally to devices, systems and methods for destabilizing liquid films disposed on liquid-impregnated surfaces and, in particular, to devices for creating nucleation sites in a film of a contact liquid that is in contact with a liquid-impregnated surface to destabilize the film of the contact liquid. In some embodiments, an article includes a liquid-impregnated surface which includes a matrix of solid features spaced sufficiently close to stably contain a liquid therebetween and/or within the matrix of solid features. The solid features have an average dimension in a range of up to 200 microns. The article includes an impregnating liquid between and/or within the matrix of solid features and is configured to contain a contact liquid different from the impregnating liquid. The article further includes a nucleation mechanism configured to nucleate and destabilize a film of the contact liquid that remains disposed on the liquid-impregnated surface after a bulk of the contact liquid has been displaced from the liquid-impregnated surface. In some embodiments, the article can be a container. In some embodiments, the nucleation mechanism can include a nucleation member which is configured to contact the film of the contact liquid thereby introducing a force which nucleates and destabilizes the film of the contact liquid.

### BRIEF DESCRIPTION OF THE DRAWINGS

FIG. 1 is a schematic illustration of a container that includes a liquid-impregnated surface and a nucleation mechanism, according to an embodiment.

FIG. 2 is a schematic illustration of a container that includes a liquid-impregnated surface and a nucleation mechanism, according to an embodiment.

FIG. 3 shows the container of FIG. 2 in a second configuration.

FIG. 4 shows the container of FIG. 2 in a third configuration.

FIG. 5 shows an enlarged view of a portion of the container of FIG. 4 indicated by the line 5.

FIGS. 6A-6F show various embodiments of a nucleation member that can be included in the container of FIG. 2.

FIG. 7 is a schematic illustration of a container that includes a liquid-impregnated surface and a nucleation mechanism, according to an embodiment.

FIG. 8 shows the container of FIG. 7 in a second configuration.

FIG. 9 is a schematic illustration of a container that includes a liquid-impregnated surface and a nucleation mechanism in a first configuration, according to an embodiment.

FIG. 10 shows the container of FIG. 9 in a second configuration.

FIG. 11 is a schematic illustration of a container that includes a liquid-impregnated surface and a nucleation mechanism, according to an embodiment.

FIG. 12 shows the container of a FIG. 11 in a second configuration

FIG. 13 shows the container of FIG. 11 in a third configuration.

FIG. 14 is a schematic illustration of a container that includes a liquid-impregnated surface and a nucleation mechanism, according to an embodiment.

FIG. 15 is a top-view of the container of FIG. 14.

FIG. 16 shows the container of FIG. 14 in a second configuration.

### DETAILED DESCRIPTION

Some “engineered” surfaces, e.g., with designed chemistry and roughness, possess substantial non-wetting (e.g., hydrophobic, hyrophobic, or oleophobic) properties that can be extremely useful in a wide variety of commercial and technological applications. For example, some hydrophobic surfaces inspired by nature, such as, for example, the lotus plant, include air pockets trapped within the micro or nano-textures of the surface which increase the contact angle of a contact liquid (e.g., water or any other aqueous liquid) disposed on the hydrophobic surface. As long as these air pockets are stable, the surface continues to exhibit hydrophobic behavior. Hydrophobic surfaces that include air pockets, however, present certain limitations including, for example: i) the air pockets can be collapsed by external wetting pressures, ii) the air pockets can diffuse away into a surrounding liquid, iii) the surface can lose robustness upon damage to its texture, iv) the air pockets may be displaced by low surface tension liquids unless a special texture design is implemented, and v) condensation or frost nuclei, which can form at the nanoscale throughout the texture, can completely transform the wetting properties and render the textured surface highly wetting.

Non-wetting surfaces can also be made by disposing a liquid-impregnated surface on a substrate. Such liquid-impregnated surfaces can be super hydrophobic, can be configured to resist ice and frost formation, and can be highly durable. Liquid-impregnated surfaces can be disposed on any substrate, for example, on the inner surface of containers or vessels, and can be configured to present a non-wetting surface to a wide variety of products, for example, food products, pharmaceuticals, nutraceuticals, health and beauty products, consumer products, or any other product, such that the product can be evacuated, detached, or otherwise displaced with substantial ease from the liquid-impregnated surface. In some cases, a thin metastable film of the product can remain disposed on the liquid-impregnated surface even after the bulk material has been displaced from the surface. While this thin film of the product can gradually decrease and break away from the liquid-impregnated surface after a period of time, the waiting time can be cumbersome for a user.

Embodiments of the containers described herein include devices, systems and methods for destabilizing thin films of product that can remain disposed on a liquid-impregnated surface after the bulk product has been displaced. Such liquid-impregnated surfaces include impregnating liquids that are impregnated into a rough or non-flat surface that includes a matrix of solid features defining interstitial regions therebetween, such that the interstitial regions include pockets of impregnating liquid. The impregnating liquid is configured to wet the solid surface preferentially and adhere to the micro-textured surface with strong capillary forces, such that the contact liquid has an extremely high advancing contact angle and an extremely low roll off angle (e.g., a roll off angle of about 1 degree and a contact angle of greater than about 100 degrees). This enables the contact liquid to displace with substantial ease on the liquid-impregnated surface. Therefore, the liquid-impregnated surfaces described herein, provide certain significant advantages over conventional super hydrophobic surfaces including one or more of the following: i) low hysteresis for the product, ii) self cleaning properties, iii) ability to withstand high drop impact pressure (i.e., are wear resistant), iv) ability to self-heal by capillary wicking upon damage, v) ability to repel a variety of liquids and/or aqueous non-Newtonian fluids, for example, water, edible liquids or aqueous formulations (e.g., ketchup, catsup, mustard, mayonnaise, syrup, honey, jelly, etc.), environmental fluids (e.g., sewage, rain water), bodily fluids (e.g., urine, blood, stool), or any other aqueous fluid (e.g. hair gel, toothpaste), vi) reduced ice formation, and vii) enhanced condensation. Examples of liquid-impregnated surfaces, methods of making liquid-impregnated surfaces and applications thereof, are described in U.S. Patent Application Publication No. 2013/0034695, entitled “Liquid-Impregnated Surfaces, Methods of Making, and Devices Incorporating the Same,” filed Aug. 16, 2012, the entire contents of which are hereby incorporated by reference herein. Examples of materials used for forming the solid features on the surface, impregnating liquids, and applications involving edible contact liquids, are described in U.S. Patent Publication No. 2013/0251952, entitled “Self-Lubricating Surfaces for Food Packaging and Food Processing Equipment,” filed Jun. 13, 2012, the entire contents of which are hereby incorporated by reference herein. Examples of non-toxic liquid-impregnated surfaces are described in U.S. Provisional application Ser. No. 14/487,794, entitled “Non-toxic Liquid-Impregnated Surfaces”, filed Sep. 16, 2013, the entire contents of which are hereby incorporated by reference herein.

Embodiments of containers described herein can include a contact liquid disposed therein which is in contact with the liquid-impregnated surface. The contact liquid can have a viscosity or surface tension such that when a bulk of the contact liquid is evacuated from the container, a thin metastable film of the contact liquid remains disposed on the liquid-impregnated surface. Such contact liquids can include, for example, laundry detergent, sugary syrups, molasses, pesticides, light creams, honey, fruit juices, household condiments, eggs, vegetable and aliphatic oils, other petroleum based products, paints, inks, colorants, fats, pharmaceuticals such as, for example, antibiotic suspensions, cough syrups, anionic suspensions, nutraceuticals such as cod liver oil, laxatives, vitamin drinks, health and beauty products such as, for example, shampoos, conditioners, face wash, lotions, gels, bodily fluids, and/or any other contact liquid that forms a film on the liquid-impregnated surface. This film can be defined as a temporary equilibrium of a continuous layer of the bulk material over the liquid-impregnated surface and can have a thickness, for example, in the range of about 100 nanometers to several millimeters. For example, the container can be turned upside down to evacuate the contact liquid but the thin film remains (e.g., attached to one or more surfaces of the container) and multiple droplets and/or streams of the contact liquid can be observed around an opening, a rim, or a nozzle of the container. The film of the contact liquid can break and decrease on its own after a period of time. However, the period of time can be inconvenient for a user who wants to use the contact liquid immediately (e.g., the film may dissociate from the container too slowly). Alternatively, as disclosed herein, the film can be physically broken by creating a nucleation site in the film of the contact liquid, for example by application of an internal or external energy. The nucleation site can destabilize the film such that the film becomes non-homogenous with the liquid-impregnated surface, rapidly spreading and evacuating the container at normal speeds. In some embodiments, to “destabilize” a film of a contact liquid may refer to the breaking of surface tension, the dissociation of the film, disrupting the morphology of the film, increasing the mobility of the film, and/or increasing the dispensing speed of the film across a surface (e.g., of the article or container).

Embodiments of containers described herein include a nucleation mechanism for creating a nucleation site in a film of a contact liquid disposed on a liquid-impregnated surface of a container such that the film is broken and rapidly evacuated from the container. Such containers can provide several advantages over contemporary containers including, for example; (i) rapid evacuation of the bulk of the contact liquid from the container because of the liquid-impregnated surface; (ii) the remaining film of the contact liquid can be broken by the nucleation mechanism such that the remaining contact liquid in the container (e.g., in the form of a film) is also evacuated rapidly from the container; (iii) the nucleation mechanism is included in the container such that a user can use it on demand.

Embodiments described herein relate generally to devices, systems and methods for destabilizing a film of a contact liquid disposed on a liquid-impregnated surface. In some embodiments, an article includes a liquid-impregnated surface which includes a matrix of solid features spaced sufficiently close to stably contain a liquid therebetween and/or within the matrix of solid features. The solid features have an average dimension in a range of up to about 200 microns. In some embodiments, the solid features can have an average dimension of up to about 1 mm. The article includes an impregnating liquid between and/or within the matrix of solid features and is configured to contain a contact liquid different from the impregnating liquid. The article further includes a nucleation mechanism configured to nucleate and destabilize a film of the contact liquid that remains disposed on the liquid-impregnated surface after a bulk of the contact liquid has been displaced from the liquid-impregnated surface. In some embodiments, the article can be a container. In some embodiments, the nucleation mechanism can include a nucleation member which is configured to contact the film of the contact liquid, thereby nucleating and destabilizing the film of the contact liquid.

As used herein, the terms “about” and “approximately” generally mean plus or minus 10% of the value stated, for example about 250 μm would include 225 μm to 275 μm, about 1,000 μm would include 900 μm to 1,100 μm.

As used herein, the terms “contact liquid”, “bulk material, “fluid”, and “product” are used interchangeably to refer to a solid or liquid that flows, for example a non-Newtonian fluid, a Bingham fluid, a high viscosity fluids, or a thixotropic fluid and is contact with a liquid-impregnated surface, unless otherwise stated.

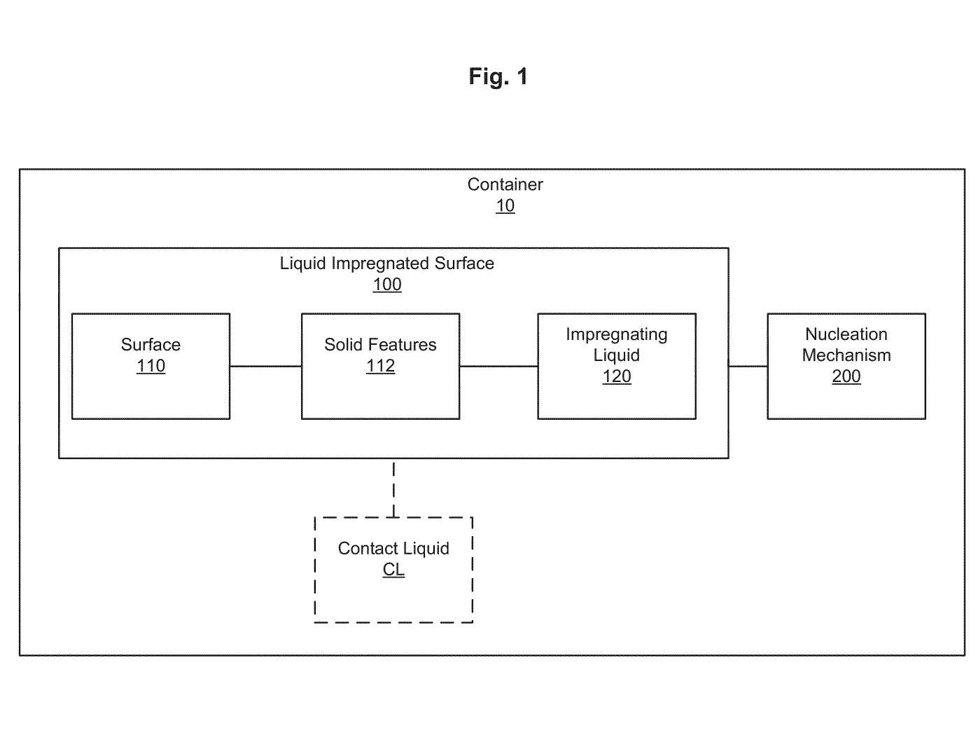

FIG. 1 illustrates a schematic block diagram of a container 10 which includes a liquid-impregnated surface 100 and a nucleation mechanism 200. The liquid-impregnated surface 100 includes a surface 110, for example, an inner surface of the container 10, a plurality of solid features 112 and an impregnating liquid 120. The impregnating liquid 120 is impregnated into the interstitial regions defined by the plurality of solid features 112. The liquid-impregnated surface 100 can be in contact with a contact liquid CL, and configured such that the contact liquid CL can easily move over the liquid-impregnated surface 100. The contact liquid CL can have a viscosity and/or surface tension such that when the contact liquid CL is evacuated from the container 10, a bulk of the contact liquid CL is evacuated rapidly from the container 10, but a film of the contact liquid CL remains disposed on the liquid-impregnated surface 100 included in the container 10.

The container 10 can include, for example, one or more tubes, bottles, vials, flasks, molds, jars, tubs, cups, caps, glasses, pitchers, barrels, bins, totes, tanks, kegs, tubs, syringes, tins, pouches, lined boxes, hoses, cylinders, and cans. The container 10 can be constructed in almost any desirable shape. In some embodiments, the container 10 can include hoses, piping, conduit, nozzles, syringe needles, dispensing tips, lids, pumps, and other surfaces for containing, transporting, or dispensing the contact liquid CL. The container 10 can be constructed from any suitable material including, for example, plastic, glass, metal, coated fibers, any other material appropriate for a given application, or combinations thereof. Suitable surfaces can include, for example, polystyrene, nylon, polypropylene, wax, polyethylene terephthalate, polypropylene, polyethylene, polyurethane, polysulphone, polyethersulfone, polytetrafluoroethylene (PTFE), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), perfluoropolyether (PFPE), polychlorotetrafluoroethylene (PCTFE), polyvinyl alcohol (PVA), polyethyleneglycol (PEG), Tecnoflon cellulose acetate, poly(acrylic acid), polypropylene oxide), D-sorbitol, and polycarbonate. The container 10 can be constructed of rigid or flexible materials. Foil-lined or polymer-lined cardboard or paper boxes can also be used to form the container 10.

The surface 110 can be an inner surface of the container 10 and can have a first roll off angle, for example, a roll off angle of a contact liquid CL (for example, laundry detergent, or any other contact liquid described herein). The surface 110 can be a flat surface, for example an inner surface of a prismatic container, or a contoured surface, for example an inner surface, of a circular, oblong, elliptical, oval or otherwise contoured container.

In some embodiments, a plurality of solid features 112 are disposed on the surface 110, such that the plurality of solid features 112 define interstitial regions between the plurality of solid features 112. The solid features 112 can be posts, spheres, micro/nano needles, nanograss, pores, cavities, interconnected pores, inter connected cavities, and/or any other random geometry that provides a micro and/or nano surface roughness. In some embodiments, the height of features can be about 10 μm, 20 μm, 30 μm, 40 μm, 50 μm, 60 μm, 70 μm, 80 μm, 90 μm, 100 μm, 200 μm, 300 μm, 400 μm, 500 μm, 600 μm, 700 μm, 800 μm, 900 μm, upto about 1 mm, inclusive of all ranges therebetween, or any other suitable height for receiving the impregnating liquid 120. In some embodiments, the height of the solids features 112 can be less than about 1 μm. For example, in some embodiments, the solid features 112 can have a height of about 1 nm, 5 nm, 10 nm, 20 nm, 30 nm 40 nm, 50 nm, 100 nm, 200 nm, 300 nm, 400 nm, 500 nm, 600 nm, 700 nm, 800 nm, 900 nm, or about 1,000 nm, inclusive of all ranges therebetween. Furthermore, the height of solid features 112 can be, for example, substantially uniform. In some embodiments, the solid features 112 can have an interstitial spacing, for example, in the range of about 1 μm to about 100 μm, or about 5 nm to about 1 μm. In some embodiments, the textured surface 110 can have hierarchical features, for example, micro-scale features that further include nano-scale features thereupon. In some embodiments, the surface 110 can be isotropic. In some embodiments, the surface 110 can be anisotropic.

The solid features 112 can be applied to, formed in, or otherwise disposed on the surface 110 using any suitable method. For example, the solid features 112 can be disposed on the inside of a container (e.g., a bottle or other food container) or be integral to the surface itself (e.g., the textures of a polycarbonate bottle may be made of polycarbonate). In some embodiments, the solid features 112 may be formed of a collection or coating of particles including, but not limited to insoluble fibers (e.g., purified wood cellulose, micro-crystalline cellulose, and/or oat bran fiber), wax (e.g., carnauba wax, Japan wax, beeswax, candelilla wax), other polysaccharides, fructo-oligosaccharides, metal oxides, montan wax, lignite and peat, ozokerite, ceresins, bitumens, petrolatuns, paraffins, microcrystalline wax, lanolin, esters of metal or alkali, flour of coconut, almond, potato, wheat, pulp, zein, dextrin, cellulose ethers (e.g., Hydroxyethyl cellulose, Hydroxypropyl cellulose (HPC), Hydroxyethyl methyl cellulose, Hydroxypropyl methyl cellulose (HPMC), Ethyl hydroxyethyl cellulose), ferric oxide, ferrous oxide, silicas, clay minearals, bentonite, palygorskite, kaolinite, vermiculite, apatite, graphite, molybdenum disulfide, mica, boron nitride, sodium formate, sodium oleate, sodium palmitate, sodium sulfate, sodium alginate, agar agar, gelatin, pectin, gluten, starch alginate, carrageenan, whey and/or any other edible solid particles described herein or any combination thereof.

In some embodiments, the solid features 112 can be disposed by exposing the surface 110 (e.g., polycarbonate) to a solvent (e.g., acetone). For example, the solvent may impart texture by inducing crystallization (e.g., polycarbonate may recrystallize when exposed to acetone). In some embodiments, the solid features 112 can be disposed by dissolving, etching, melting, reacting, treating, or spraying on a foam or aerated solution, exposing the surface to electromagnetic waves such as, for example ultraviolet (UV) light or microwaves, or evaporating away a portion of a surface, leaving behind a textured, porous, and/or rough surface that includes a plurality of the solid features 112. In some embodiments, the solid features 112 can be defined by mechanical roughening (e.g., tumbling with an abrasive), spray-coating or polymer spinning, deposition of particles from solution (e.g., layer-by-layer deposition, evaporating away liquid from a liquid/particle suspension), and/or extrusion or blow-molding of a foam, or foam-forming material (for example a polyurethane foam). In some embodiments, the solid features 112 can also be formed by deposition of a polymer from a solution (e.g., the polymer forms a rough, porous, or textured surface); extrusion or blow-molding of a material that expands upon cooling, leaving a wrinkled surface; and application of a layer of a material onto a surface that is under tension or compression, and subsequently relaxing the tension or compression of surface beneath, resulting in a textured surface.

In some embodiments, the solid features 112 are disposed through non-solvent induced phase separation of a polymer, resulting in a sponge-like porous structure. For example, a solution of polysulfone, poly(vinylpyrrolidone), and DMAc may be cast onto a substrate and then immersed in a bath of water. Upon immersion in water, the solvent and non-solvent exchange, and the polysulfone precipitates and hardens.

The solid features 112 can include micro-scale features such as, for example, posts, spheres, nano-needles, pores, cavities, interconnected pores, grooves, ridges, interconnected cavities, or any other random geometry that provides a micro and/or nano surface roughness. In some embodiments, the solid features 112 can include particles that have micro-scale or nano-scale dimensions which can be randomly or uniformly dispersed on a surface. Characteristic spacing between the solid features 112 can be about 1 mm, about 900 μm, about 800 μm, about 700 μm, about 600 μm, about 500 μm, about 400 μm, about 300 μm, about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, or 100 nm, about 90 nm, about 80 nm, about 70 nm, about 60 nm, about 50 nm, about 40 nm, about 30 nm, about 20 nm, about 10 nm, or about 5 nm. In some embodiments, characteristic spacing between the solid features 112 can be in the range of about 100 μm to about 100 nm, about 30 μm to about 1 μm, or about 10 μm to about 1 μm. In some embodiments, characteristic spacing between solid features 112 can be in the range of about 100 μm to about 80 μm, about 80 μm to about 50 μm, about 50 μm to about 30 μm, about 30 μm to about 10 μm, about 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 5 nm, inclusive of all ranges therebetween.

In some embodiments, the solid features 112, for example solid particles, can have an average dimension of about 200 μm, about 100 μm, about 90 μm, about 80 μm, about 70 μm, about 60 μm, about 50 μm, about 40 μm, about 30 μm, about 20 μm, about 10 μm, about 5 μm, 1 μm, about 100 nm, about 90 nm, about 80 nm, about 70 nm, about 60 nm, about 50 nm, about 40 nm, about 30 nm, about 20 nm, about 10 nm, or about 5 nm. In some embodiments, the average dimension of the solid features 112 can be in the range of about 100 μm to about 100 nm, about 30 μm to about 10 μm, or about 20 μm to about 1 μm. In some embodiments, the average dimension of the solid features 112 can be in the range of about 100 μm to about 80 μm, about 80 μm to about 50 μm, about 50 μm to about 30 μm, or about 30 μm to about 10 μm, or 10 μm to about 1 μm, about 1 μm to about 90 nm, about 90 nm to about 70 nm, about 70 nm to about 50 nm, about 50 nm to about 30 nm, about 30 nm, to about 10 nm, or about 10 nm to about 5 nm, inclusive of all ranges therebetween. In some embodiments, the height of the solid features 112 can be substantially uniform. In some embodiments, the surface 110 can include hierarchical features, for example micro-scale features that further include nano-scale features disposed thereupon.

In some embodiments, the solid features 112 (e.g., particles) can be porous. The characteristic pore size (e.g., pore widths or lengths) of particles can be about 5,000 nm, about 3,000 nm, about 2,000 nm, about 1,000 nm, about 500 nm, about 400 nm, about 300 nm, about 200 nm, about 100 nm, about 80 nm, about 50, or about 10 nm. In some embodiments, the characteristic pore size can be in the range of about 200 nm to about 2 μm, or about 10 nm to about 1 μm, inclusive of all ranges therebetween.

In some embodiments, the impregnating liquid 120 is disposed on the surface 110 such that the impregnating liquid 120 impregnates the interstitial regions defined by the plurality of solid features 112, for example, pores, cavities, or otherwise inter-feature spacing defined by the surface 110, such that substantially no air remains in the interstitial regions. The interstitial regions can be dimensioned and configured such that capillary forces retain part of the impregnating liquid 120 in the interstitial regions. The impregnating liquid 120 disposed in the interstitial regions of the plurality of solid features 112 is configured to define a second roll off angle less than the first roll of angle (i.e., the roll of angle of the unmodified surface 110. In some embodiments, the impregnating liquid 120 can have a viscosity at room temperature of less than about 1,000 cP, for example about 50 cP, about 100 cP, about 150 cP, about 200 cP, about 300 cP, about 400 cP, about 500 cP, about 600 cP, about 700 cP, about 800 cP, about 900 cP, or about 1,000 cP, inclusive of all ranges therebetween. In some embodiments, the impregnating liquid 120 can have viscosity of less than about 1 cP, for example, about 0.1 cP, 0.2 cP, 0.3 cP, 0.4 cP, 0.5 cP, 0.6 cP, 0.7 cP, 0.8 cP, 0.9 cP, or about 0.99 cP, inclusive of all ranges therebetween. In some embodiments, the impregnating liquid 120 can fill the interstitial regions defined by the solid features 112 such that the impregnating liquid 120 forms a layer of at least about 5 nm thick above the plurality of solid features 112 disposed on the surface 110. In some embodiments, the impregnating liquid 120 forms a layer of at least about 1 μm above the plurality of solid features 112 disposed on the surface 110.

The impregnating liquid 120 may be disposed in the interstitial spaces defined by the solid features 112 using any suitable means. For example, the impregnating liquid 120 can be sprayed or brushed onto the textured surface 110 (e.g., a texture on an inner surface of a bottle). In some embodiments, the impregnating liquid 120 can be applied to the textured surface 110 by filling or partially filling a container that includes the textured surface 110. The excess impregnating liquid 120 is then removed from the container. In some embodiments, the excess impregnating liquid 120 can be removed by adding a wash liquid (e.g., water, surfactants, acids, bases, solvents, etc.) to the container to collect or extract the excess liquid from the container. In some embodiments, the excess impregnating liquid may be mechanically removed (e.g., pushed off the surface with a solid object or fluid), absorbed off of the surface 110 using another porous material, or removed via gravity or centrifugal forces. In some embodiments, the impregnating liquid 120 can be disposed by spinning the surface 110 (e.g., a container) in contact with the liquid (e.g., a spin coating process), and condensing the impregnating liquid 120 onto the surface 110. In some embodiments, the impregnating liquid 120 is applied by depositing a solution with the impregnating liquid and one or more volatile liquids (e.g., via any of the previously described methods) and evaporating away the one or more volatile liquids.

In some embodiments, the impregnating liquid 120 can be applied using a spreading liquid that spreads or pushes the impregnating liquid along the surface 110. For example, the impregnating liquid 120 (e.g., ethyl oleate) and spreading liquid (e.g., water) may be combined in a container and agitated or stirred. The fluid flow within the container may distribute the impregnating liquid 120 around the container as it impregnates the solid features 112.

In some embodiments, the impregnating liquid 120 can include, silicone oil, a perfluorocarbon liquid, halogenated vacuum oil, greases, lubricants, (such as Krytox 1506 or Fromblin 06/6), a fluorinated coolant (e.g., perfluoro-tripentylamine sold as FC-70, manufactured by 3M), an ionic liquid, a fluorinated ionic liquid that is immiscible with water, a silicone oil comprising PDMS, a fluorinated silicone oil such as, for example polyfluorosiloxane, or polyorganosiloxanes, a liquid metal, a synthetic oil, a vegetable oil, an electro-rheological fluid, a magneto-rheological fluid, a ferrofluid, a dielectric liquid, a hydrocarbon liquid such as mineral oil, polyalphaolefins (PAO), or other synthetic hydrocarbon co-oligomers, a fluorocarbon liquid, for example, polyphenyl ether (PPE), perfluoropolyether (PFPE), or perfluoroalkanes, a refrigerant, a vacuum oil, a phase-change material, a semi-liquid, polyalkylene glycol, esters of saturated fatty and dibasic acids, polyurea, grease, synovial fluid, bodily fluid, or any other aqueous fluid or any other impregnating liquid described herein.

The ratio of the solid features 112 (e.g., particles) to the impregnating liquid 120, can be configured to ensure that no portion of the solid features 112 protrudes above the liquid-product interface. For example, in some embodiments, a ratio of the solid features 112 to the impregnating liquid 120 on the surface 110 can be less than about 15%, or less than about 5%. In some embodiments, the ratio of the solid features 112 to the impregnating liquid 120 can be less than about 50%, about 45%, about 40%, about 35%, about 30%, about 25%, about 20%, about 15%, about 10%, about 5%, or less than about 2%. In some embodiments, the ratio of the solid features 112 to the impregnating liquid 120 can be in the range of about 5% to about 50%, about 10% to about 30%, or about 15% to about 20%, inclusive of all ranges therebetween. In some embodiments, a low ratio can be achieved using surface textures that are substantially pointed, caved, or are rounded. By contrast, surface textures that are flat may result in higher ratios, with too much solid material exposed at the surface.

In some embodiments, the liquid-impregnated surface 100 can have an “emerged area fraction,” “φ,” which is defined as a representative fraction of the projected surface area of the liquid-impregnated surface 100 corresponding to non-submerged solid at room temperature, of less than about 0.30, about 0.25, about 0.20, about 0.15, about 0.10, about 0.05, about 0.01, or less than about 0.005. In some embodiments, φ can be greater than about 0.001, about 0.005, about 0.01, about 0.05, about 0.10, about 0.15, or greater than about 0.20. In some embodiments, φ can be in the range of about 0 to about 0.25. In some embodiments, φ can be in the range of about 0 to about 0.01. In some embodiments, φ can be in the range of about 0.001 to about 0.25. In some embodiments, φ can be in the range of about 0.001 to about 0.10.

The liquid-impregnated surface 100 that is in contact with the contact liquid CL defines four distinct phases: an impregnating liquid 120, a surrounding gas (e.g., air), the contact liquid CL, and the surface 110 with the solid features 112 disposed thereon. The interactions between the different phases determines the morphology of the contact line (i.e., the contact line that defines the contact angle of a contact liquid droplet with the liquid-impregnated surface) because the contact line morphology substantially impacts the droplet pinning and therefore contact liquid CL mobility on the surface. Details of such interactions and their impact on displacement of a contact liquid in contact with a liquid-impregnated surface are described in Exhibit A, attached hereto.

The nucleation mechanism 200 is configured to nucleate and destabilize a film of the contact liquid CL disposed on the liquid-impregnated surface 100, after the bulk of the contact liquid CL is evacuated from the container 10. This destabilizes the contact liquid CL film, thus urging the contact liquid CL film to rapidly evacuate from the container 10. At least a portion of the nucleation mechanism 200 can be disposed in an interior volume defined by the container 10 which houses the contact liquid CL. In some embodiments, nucleation mechanism 200 can be a passive mechanism that does not require a user to activate the mechanism. In some embodiments, the nucleation mechanism 200 can be an active mechanism that can be engaged and activated by a user.

In some embodiments, a nucleation mechanism 200 can include a nucleation member (not shown) disposed in the interior volume defined by the container 10. The nucleation member can be configured to contact the film of the contact liquid to create a nucleation site therein, and destabilize the film. In some embodiments, the nucleation member can be tethered to a base of container 10, for example, to prevent the nucleation member from being expelled out of the container 10 as the bulk of the contact liquid CL is evacuated from the container 10 and/or to provide a tensile force on the nucleation member against the buoyancy. Such a nucleation member can be formed from a material that has a density less than the density of the contact liquid CL disposed in the internal volume defined by the container 10, such that the nucleation member floats on the surface of the contact liquid CL. As the contact liquid is poured out of the container 10, the nucleation member can contact the film of contact liquid CL that remains disposed on the liquid-impregnated surface 100, such that a nucleation site is formed on the film which breaks the film and urges the remaining contact liquid CL to evacuate the container 10. The nucleation member can have any suitable shape, for example, a sphere (e.g., a solid or hollow ball), hemisphere, a pyramid, a star, a diamond, any other suitable shape, and can also include features on an outer surface of the nucleation member, for example, jacks, needles, blades, razor edges, bumps, ridges, or any other suitable feature.

In some embodiments, the nucleation mechanism 200 can include a nucleation member coupled to a biasing member (not shown). The biasing member can be disposed in a housing (not shown) disposed on an outer surface of the container 10, for example, an outer surface of a base of the container, such that the biasing member is disposed outside the internal volume defined by the container 10. In some embodiments, the housing can be monolithically formed with the container 10. For example, the housing can be included in a sidewall of the container. The nucleation member can be disposed in the internal volume and can include barbs, needles, pins, sharp edges, pointed tips, or other features configured to nucleate and destabilize a film of the contact liquid CL. The biasing member, for example a spring, can be engaged and disengaged by a user such that the nucleation member contacts the contact liquid CL films and destabilizes it.

In some embodiments, the nucleation mechanism 200 can include a nucleation member which can be mounted on a pivot in the internal volume defined by the container 10 and configured to swing, for example, in a pendulum motion. The swinging motion can cause the nucleation member to contact the film of the contact liquid CL and destabilize it. In some embodiments, the nucleation member can be configured to be displaced laterally to contact the film of the contact liquid CL. The nucleation member can be coupled to biasing member, for example, a spring via members configured to convert translational motion to rotational motion, for example gears, cams, crank shafts, or any other suitable members, such that when the biasing member is engaged by a user, the nucleation member swings and contacts the contact liquid CL film to destabilize it. The nucleation member can also include sharp edges or pointed tips to facilitate the nucleation.

In some embodiments, the nucleation mechanism 200 can include a housing (not shown) defining an internal volume disposed on an external sidewall of the container 10. The housing can be filled with a gas, for example air, nitrogen or any other inert gas. The internal volume defined by the housing can be in fluidic communication with the internal volume of the container 10 via an opening, for example an orifice, a nozzle, a jet, a slit, or any other shaped opening (e.g., oblong, pentagon, hexagon, octagon, etc.), configured to prevent the contact liquid CL disposed in the container 10 from flowing into the housing. A plunger (not shown) can be disposed in the housing. The plunger can be configured to be engaged by a user such that the plunger can expel the gas disposed in the housing, into the internal volume defined by the container 10. The gas bubbles can contact a contact liquid CL film disposed on the liquid-impregnated surface 100 of the container thereby creating nucleation sites and destabilizing the film. In some embodiments, the nucleation mechanism can include a plurality of voids disposed on an internal side wall of the container 10, for example on a base of the container 10. In some embodiments, the voids can be monolithically formed on the sidewalls of the container. Each of the voids can be configured to trap a gas, for example air, within the voids. When a contact liquid CL is disposed within the container 10, inversion of the container 10 can cause the gas bubbles to rise in the contact liquid CL because of their lighter density. Thus, the gas bubbles can slowly diffuse from the voids and into the contact liquid CL, such that the bubbles form nucleation sites in the film of the contact liquid CL and destabilize it.

In some embodiments, the nucleation mechanism can include a biasing member (e.g., a compression spring) disposed at the base of the container 10. The biasing member can be coupled to a plunger. The biasing member can be configured to be compressed by the hydrostatic pressure of the bulk contact liquid CL disposed in the inside volume defined by the container 10. As the bulk contact liquid CL is evacuated from the container 10, for example, by inverting the container 10, the hydrostatic pressure on the biasing member can be released. This can urge the biasing member to its uncompressed state, such that the biasing member disrupts a film of the contact liquid CL disposed on the liquid impregnated surface 100. Thus, the film of the contact liquid can be nucleated and destabilized.

In some embodiments, the nucleation mechanism 200 can include a turbulence generation member (not shown) such as, for example, hydrodynamic power wheels, turbines, pin wheels, or any other suitable turbulence generation member, disposed in an internal volume defined by the container 10. The turbulence generation member can be configured such that it barely touches the liquid-impregnated surface 100 disposed on the inner surface of the container 10 (e.g., a blade of a hydrodynamic power wheel could be disposed in close proximity with but not touching the liquid-impregnated surface 100). The turbulence generation member can be configured to generate a turbulent flow near a film of a contact liquid CL disposed on the liquid-impregnated surface 100 when engaged by a user. The torque from the turbulent flow can urge some of the contact liquid CL to displace from the liquid-impregnated surface 100 thereby creating a liquid-vapor surface in the film of the contact liquid CL which spontaneously nucleates and destabilizes. In some embodiments, the turbulence generating member can be mechanically powered or driven by a deadfall weight and lever which can be activated, for example, by inverting the container 10. In some embodiments, the turbulence generating member can be a wheel which can be disposed in proximity of the liquid-impregnated surface 100 and configured to be rotated about its axis. In some embodiments, a power mechanism, for example, a winding mechanism, a spring, a twisting knob, or any other power mechanism can be used to drive the turbulence generation member.

In some embodiments, the nucleation mechanism 200 can use vibrational forces to destabilize a film of the contact liquid CL disposed on the liquid-impregnated surface 100. For example, the container 10 can be a rotatable corrugated cap which can include a vibration generation feature such as, for example, a corrugated plastic ring or cog coupled thereto. A user can rotate the corrugated cap, such that the vibration generation feature vibrates the film of the contact liquid CL or physically shears the film thereby destabilizing the film. In some embodiments, sonication can be used to destabilize the film.

In some embodiments, a reservoir of gas, for example air, can be included in the container 10. In a first configuration, the reservoir of gas can be fluidically isolated from the internal volume of the container 10 via one or more gate valves. In a second configuration, a user can urge the container 10 into a second configuration such that the gate valves open releasing the gas into the internal volume of the container 10. For example, the container 10 can be a double side walled cap, which can be rotated to open the gate valves. The gas can be released under pressure or through capillary wicking which can destabilize the film of the contact liquid CL. In some embodiments, any other chemical which can nucleate and destabilize the film of the contact liquid CL, can be used. In some embodiments, the gas can be pressurized in the reservoir, or can be pressurized by a user upon each use, for example, when the container 10 is a reusable container. In some embodiments, the reservoir can be under vacuum such that opening the gate valves will create a suction force on the film of the contact liquid sufficient to nucleate and destabilize the film.

In some embodiments, nucleation mechanism 200 can include a chemical configured to nucleate and destabilize the film of the contact liquid CL disposed on the liquid-impregnated surface 100. For example, in some embodiments, the nucleation mechanism 200 can include a plurality of capillary tubes disposed on an internal side wall of the container 10. The capillary tubes can be formed from consumer packaging material (e.g., plastics), carbon nanotubes, polymer nanotubes, organosilicon compounds, metals, ceramics, polymers, and/or other natural porous materials. The capillary tubes can be configured to hold a liquid-antagonist, for example, a weak acid, that can contact a portion of the film of the contact liquid CL in proximity to the capillary tubes and dissolve a portion of the film, thereby creating a vapor-solid nucleation site to destabilize the film. The dissolved or reacted portion of the film can be replaced by the hemi-wicking of the impregnating liquid 120 included in the liquid-impregnated surface 100. In some embodiments, the capillary tubes can be embedded into a side wall of the container 10 or etched into the side wall of the container 10. In some embodiments, the capillary tubes can be in fluid communication with a reservoir of the liquid-antagonist. Such a reservoir can be disposed on a side wall of the container 10. In some embodiments, a mechanism for pumping the liquid-antagonist into the internal volume of the container 10 can also be included in the container 10. Such mechanisms can include for example, a button, a lever, a spring actuated air pump, a key or lock system, a digital signal or battery powered air pump, or mechanical shearing motions. In some embodiments, the capillary tubes can be coated with a material (e.g., a hydrophobic or hydrophilic material) that has affinity for the liquid-antagonist, such that the liquid-antagonist is siphoned into the capillary tubes.

In some embodiments, a portion of an inner surface of a side wall of the container 10 can be configured to be non-wettable by a contact liquid CL disposed in an internal volume defined by the container. For example, the portion can include a non-wettable patch (e.g., a silicone patch) or an immiscible coating. The non-wettable portion of the inner surface can be concealed by a side wall of the container 10 in a first configuration and a contact liquid CL film can be disposed on an inner surface of the side wall of the container 10. In a second configuration, the non-wettable portion can be revealed, for example, by engaging, a spring, switch, rod, or any other mechanism, such that the non-wettable portion contacts the film of the contact liquid, thereby nucleating and destabilizing the contact liquid CL film.

In some embodiments, a voltage, a current, a magnetic field, or an electromagnetic field can be used to nucleate and destabilize the film of the contact liquid CL in contact with the liquid-impregnated surface 100. For example, the contact liquid CL can be paramagnetic or ferromagnetic, such that the bulk contact liquid CL exhibits a paramagnetic or ferromagnetic moment. A magnetic field or an electromagnetic field (e.g., an AC magnetic field) can be applied to the contact liquid CL such that the contact liquid CL molecules are repelled from the liquid-impregnated surface. In some embodiments, an electric potential can be used to nucleate and destabilize the film. For example, the liquid-impregnating surface 100 can include an impregnating liquid 120 that has an opposite charge to the contact liquid CL. Thus, when a voltage having an opposite polarity to the impregnating liquid 120 is applied to the impregnating liquid 120, for example through a conducting side wall of the container 100, the impregnating liquid 120 is attracted towards the side wall of the container 100. Conversely, the film of the contact liquid CL is repelled away from the side wall of the container 10. This can nucleate and destabilize the film urging it to breakaway from the liquid-impregnated surface 100 and be expelled from the container 10. In some embodiments, a battery can be used to apply the electric potential.

Having described above various general principles, several exemplary embodiments of these concepts are now described. These embodiments are only examples, and many other configurations of a container that includes a liquid-impregnated surface and a nucleation mechanism, are contemplated.

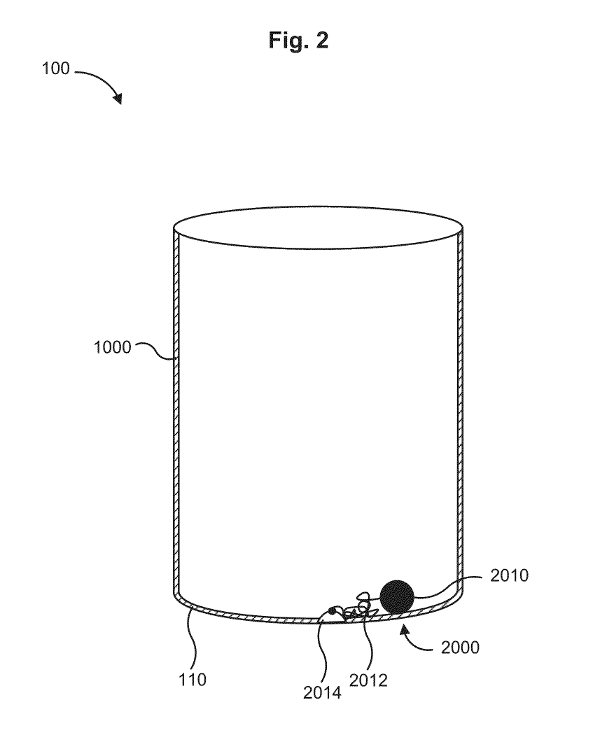

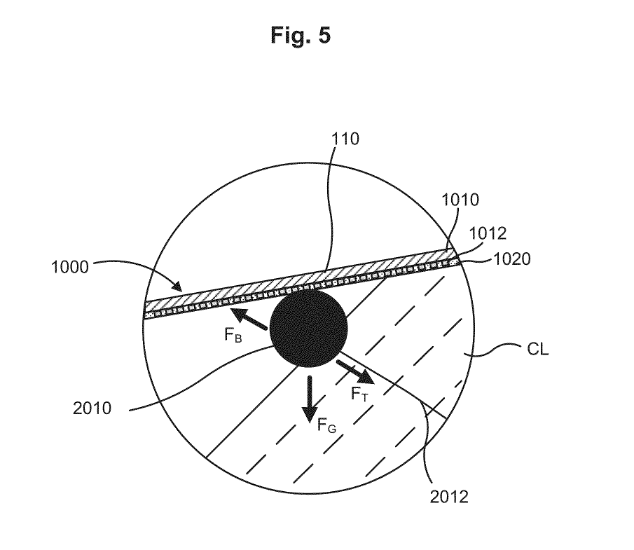

In some embodiments, a container can include a nucleation mechanism that includes a tethered nucleation member that can float in a contact liquid. Referring now to FIGS. 2-5, a container 100 includes a liquid-impregnated surface 1000 and a nucleation mechanism 2000. A contact liquid CL can optionally be disposed in the internal volume defined by the container 100. The liquid-impregnated surface 1000 includes a surface 1010, for example, an inner surface of a side wall 110 the container 100, a plurality of solid features 1012 and an impregnating liquid 1020 (FIG. 5). The impregnating liquid 1020 is impregnated into the interstitial regions defined by the plurality of solid features 1012. The liquid-impregnated surface 1100 can be substantially similar to the liquid-impregnated surface 100 described with respect to FIG. 1, and is therefore not described in further detail herein. The liquid-impregnated surface 1000 can be in contact with the contact liquid CL such that the contact liquid CL can easily move over the liquid-impregnated surface 1000. The contact liquid CL can have a viscosity and/or surface tension such that when the contact liquid CL is evacuated from the container 100, a bulk of the contact liquid CL is evacuated rapidly from the container 100 but a film of the contact liquid CL remains disposed on the liquid-impregnated surface 1000 included in the container 100.

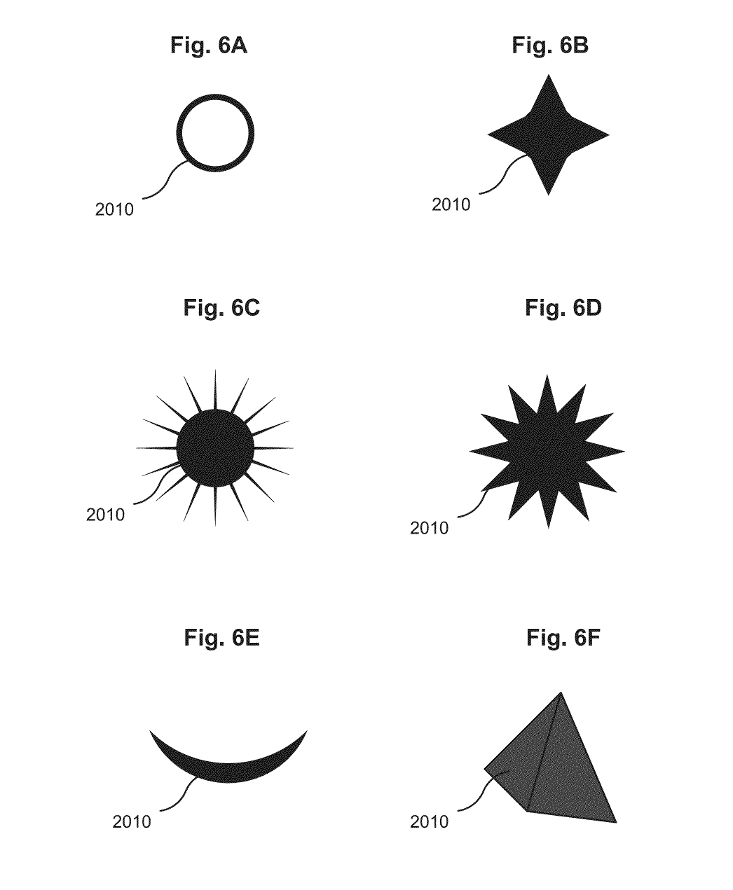

As shown in FIG. 2, the nucleation mechanism 2000 includes a nucleation member 2010. The nucleation member 2010 can be formed from a material which has a density less than the density of the contact liquid CL, such that the nucleation member 2010 can float on the bulk contact liquid CL. Such materials can include, for example, plastic (polyethylene, polypropylene, polyvinylchloride, high density polyethylene, polytetrafluoroethylene, etc.), wood, polymers, foams, foil, metals, ceramics, or any other suitable material or combination thereof. In some embodiments, the nucleation member 2010 can include a solid ball as shown in FIG. 2. Referring also now to FIG. 6A-F, in some embodiments the nucleation member 2010 can include a hollow ball (e.g., a hollow metal ball). The material used to form the nucleation member 2010 can be configured based on the density of the bulk contact liquid CL such that the nucleation member 2010 floats in the bulk contact liquid CL. In some embodiments, the chemical formulation or surface chemistry of the nucleation member 2010 can be formulated to allow the nucleation member 2010 to float in the contact liquid CL. The nucleation member 2010 can be configured to have any shape and can also include sharp edges, or pointed features disposed on an external surface of the nucleation member 2010. In some embodiments, the nucleation member 2010 can have triangular projections, for example jacks disposed on the external surface of the nucleation member 2010 (FIG. 6B). In some embodiments, the nucleation member 2010 can be a spherical member that includes a plurality of pin-like needles (FIG. 6C) or hexagonal needles (FIG. 6D) disposed on an external surface of the nucleation member 2010. In some embodiments, the nucleation member 2010 can be shaped as a crescent that has sharp edges (FIG. 6E). In some embodiments, the nucleation member 2010 can include a pyramidal structure (FIG. 6F). In some embodiments, the nucleation member 2010 can be shaped as a rectangle, a pentagon, a hexagon, an octagon, an oval, an ellipse, or any other suitable shape or combination thereof, that can have pointed or sharp features disposed on the external surface of the nucleation member 2010. Moreover, in any of these embodiments, the nucleation member 2010 can be solid or hollow.

The nucleation member 2010 is tethered to an anchor 2014 disposed on a bottom surface 110 of the container 100 via a tether 2012. The tether 2012 can be a string, or a chain, formed from an inert material that is not corroded by the contact liquid CL. Such materials can include, for example, fabric, plastic, rubber, silicon, or any other suitable material. In some embodiments, the tether 2012 can be formed from an elastic material, for example, to increase a tensile force exerted by the tether 2012 on the nucleation member 2010. The anchor 2014 can include a hook, an eye bolt, or an adhesive, configured to keep the nucleation member 2010 tethered to the bottom surface 110 of the container 100.

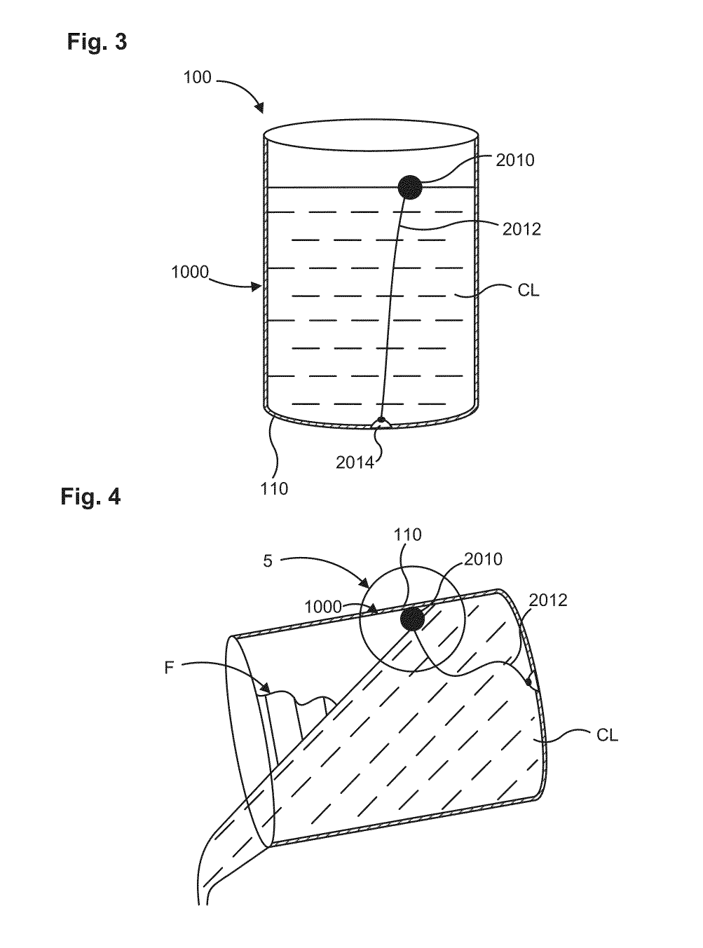

The nucleation member 2010 is configured to make contact with a film of the contact liquid CL disposed on the liquid-impregnated surface 1000, such that a nucleation site is created in the film, causing it to destabilize and break away from the surface. In a first configuration, as shown in FIG. 2, the container 100 can be empty and the nucleation member 2010 can be disposed on the bottom surface 110 of the container 100. In a second configuration, shown in FIG. 3, a contact liquid CL can be disposed in the internal volume defined by the container 100, such that the contact liquid CL is in contact with the liquid-impregnated surface 1000. In this configuration, the nucleation member 2010 floats in the bulk contact liquid CL, but remains tethered to the anchor 2014 via the tether 2012. In a third configuration, as shown in FIG. 4, a user can tip over the container 100 to expel the bulk contact liquid CL out of the container 100. While the bulk of the contact liquid CL is easily expelled from the container 100, a film F of the contact liquid CL can remain disposed on the liquid-impregnated surface 1000. In this configuration, the nucleation member 2010 floats on the bulk contact liquid CL, and makes contact with the film F disposed on the liquid-impregnated surface 1000. As shown in the enlarged view of FIG. 5, in the third configuration three forces act on the nucleation member 2010. A force of gravity F_{G}, a tether force F_{T} that pulls the nucleation member 2010 towards the anchor 2014 and prevents the nucleation member 2010 from being expelled from the container 100, and a buoyant force F_{B} that urges the nucleation member 2010 towards the side-wall 110 of the container 100. The nucleation member 2010 can drag along the inner surface of the side wall 110 of the container 100 and contact the film F of the contact liquid CL disposed on the liquid-impregnated surface 1000. The nucleation member 2010 can thereby create one or more nucleation sites in the film F, urging it to destabilize, as shown in FIG. 4, such that the film F is rapidly expelled from the container 100.

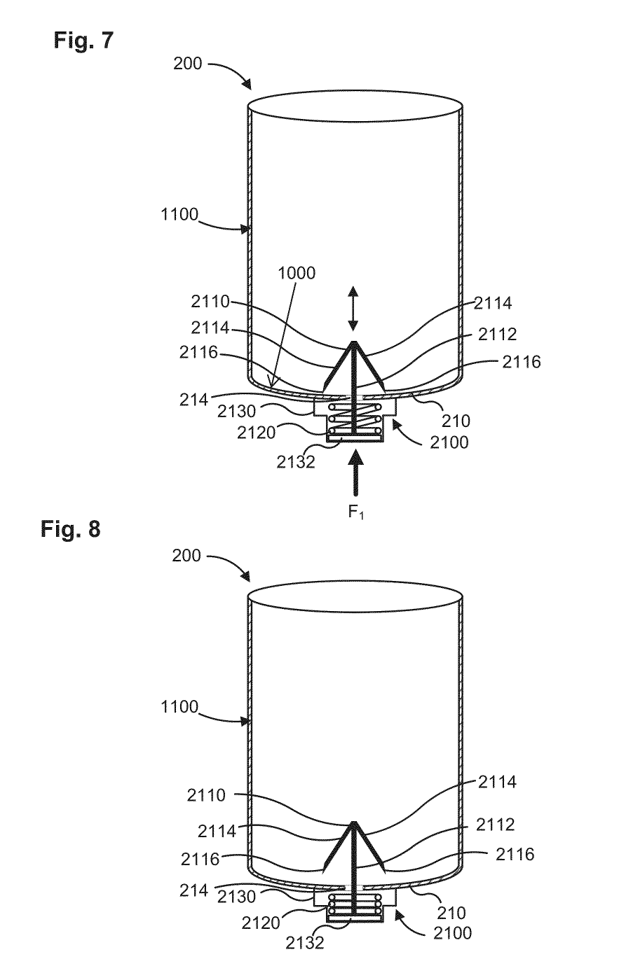

In some embodiments, a container can include a nucleation mechanism that can be engaged by the user on demand. Referring now to FIGS. 7-8, a container 200 includes a liquid-impregnated surface 1100 and a nucleation mechanism 2100. A contact liquid can optionally be disposed in the internal volume defined by the container 200. The liquid-impregnated surface 1100 includes a surface, for example, an inner surface of a side wall 210 of the container 200, a plurality of solid features and an impregnating liquid. The impregnating liquid is impregnated into the interstitial regions defined by the plurality of solid features. The liquid-impregnated surface 1100 can be substantially similar to the liquid-impregnated surface 100 described with respect to FIG. 1, and is therefore, not described in further detail herein. The liquid-impregnated surface 1100 can be in contact with the contact liquid, such that the contact liquid can easily displace over the liquid-impregnated surface 1100. The contact liquid can have a viscosity and/or surface tension such that when the contact liquid is evacuated from the container 200, a bulk of the contact liquid is evacuated rapidly from the container 200 but a film of the contact liquid remains disposed on the liquid-impregnated surface 1100.

The nucleation mechanism 2100 includes a nucleation member 2110 disposed in the internal volume defined by the container 200. The nucleation member 2110 includes a rod 2112 that has a set of hooks 2114, such that a distal end of each of the set of hooks 2114 is coupled to a distal end of the rod 2112. A proximal end of each of the set of hooks 2114 can include a barb 2116 which is disposed in proximity of, or in contact with, the inner surface of the side wall 210. The side wall 210 can include an orifice 214 such that a portion of the rod 2112 passes through the orifice 214 and is disposed outside the internal volume of the container 200. A proximal end of the rod 2112, which is disposed outside the internal volume of the container 200, is coupled to a platform 2132. For example, the rod 2112 can be welded, bolted, screwed, or coupled with an adhesive to platform 2132. In some embodiments, the nucleation member 2110 can be formed monolithically with the platform 2132. A housing 2130 is disposed on an outer surface of the side wall 210 of the container 200, such that the platform 2132 and the distal end of the rod 2112 are disposed in an internal volume defined by the housing 2130. A biasing member 2120 is also disposed in the housing 2130 and coupled to the platform 2132. The biasing member 2120 can include, for example a spring (e.g., a helical spring, a coil spring, a compression spring, or a leaf spring), or any other suitable biasing member. The housing 2130 is hermetically sealed from the internal volume defined by the container 200, for example via gaskets or sealants. This ensures that the rod 2112 of the nucleation member 2110 can slide within the orifice 214 from the housing 2130 to the internal volume of the container 200, without the contact liquid flowing into the housing 2130.

In a first configuration shown in FIG. 7, a film of the contact liquid can be disposed on the liquid-impregnated surface 1000, and the biasing member 2132 can be in an unbiased state. In the first configuration, the tips 2116 of the set of hooks 2114 are in proximity with or in contact with the liquid-impregnated surface 1000 disposed on the bottom surface 210 of the container 200, but not disrupting the contact liquid CL film. To engage the nucleation member 2100, a user can apply a force on the platform 2132 as shown by the arrow F₁. At least a portion of the housing 2130 can be flexible or deformable to allow a user to engage the platform 2132, via a side wall of the housing 2130. In some embodiments, the housing 2130 can define a lumen such that the platform 2132 can slide within the lumen when engaged by a user. In some embodiments, the housing 2130 can define an opening on a bottom surface of the housing 2130 proximal to the platform 2132 configured to allow the user to engage the platform 2132 without needing to apply a force on the side wall of the housing 2130. Engaging the platform 2132 urges the nucleation member 2110 to displace from the first configuration to a second configuration shown in FIG. 8. In the second configuration, the barbs 2116 are no longer in proximity with the liquid-impregnated surface 1100, and a contact liquid film disposed thereon. Engaging the platform 2132 also engages the biasing member 2120, such that in the second configuration, the biasing member 2120 is biased (e.g., compressed). When the user removes the force shown by the arrow F₁, the biasing member 2120 urges the nucleation member 2110 to return to the first configuration. As the nucleation member 2110 returns to the first configuration, the barbs 2116 of each of the plurality of hooks 2114 can pierce the film of the contact liquid disposed on the liquid-impregnated surface 1100 with a kinetic energy sufficient to nucleate the film of the contact liquid. This creates nucleation sites in the film, which destabilizes the film and causes the contact liquid film disposed on the liquid-impregnated surface 1100 to rapidly expel from the container 200. A constant velocity profile can be used to estimate the impact force required to nucleate the film.

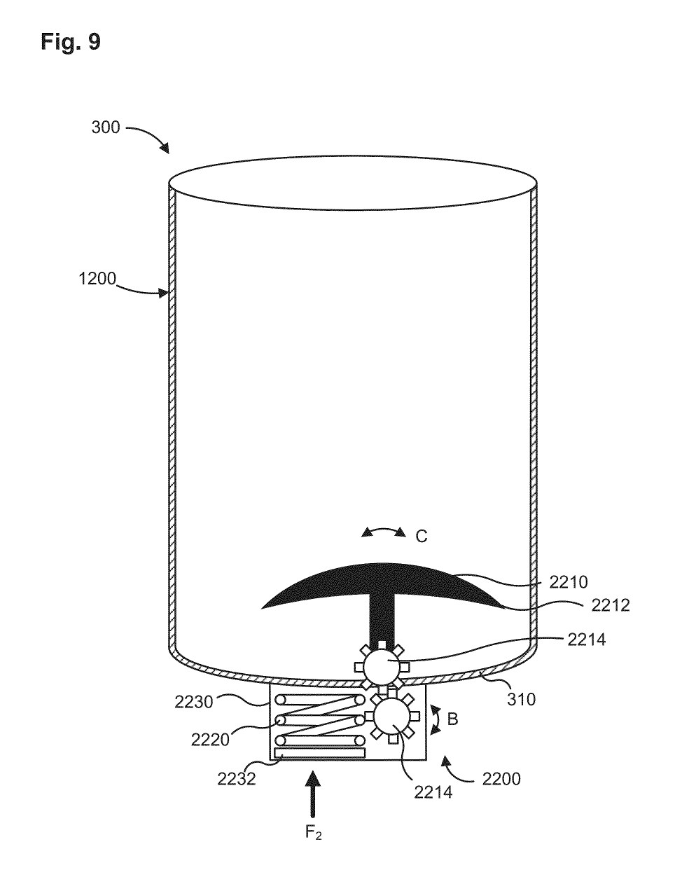

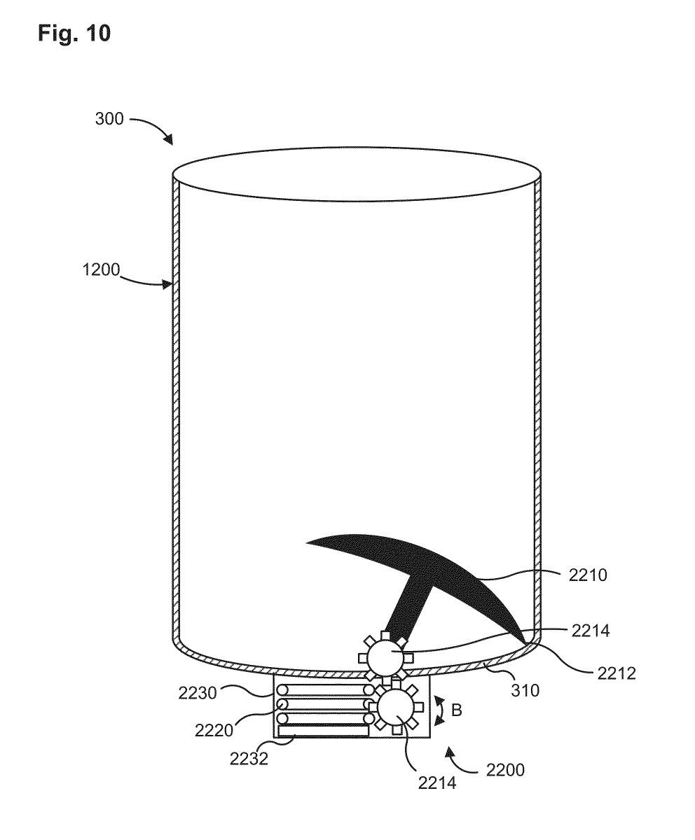

In some embodiments, a user activatable nucleation mechanism can include a nucleation member that can swing about a pivot. Referring now to FIGS. 9-10, a container 300 includes a liquid-impregnated surface 1200 and a nucleation mechanism 2200. A contact liquid can optionally be disposed in the internal volume defined by the container 300. The liquid-impregnated surface 1200 includes a surface, for example, an inner surface of a side wall 310 of the container 300, a plurality of solid features and an impregnating liquid. The impregnating liquid is impregnated into the interstitial regions defined by the plurality of solid features. The liquid-impregnated surface 1200 can be substantially similar to the liquid-impregnated surface 100 described with respect to FIG. 1, and is therefore not described in further detail herein. The liquid-impregnated surface 1200 can be in contact with the contact liquid, such that the contact liquid can easily displace over the liquid-impregnated surface 1200. The contact liquid can have a viscosity and/or surface tension such that when the contact liquid is evacuated from the container 300, a bulk of the contact liquid is evacuated rapidly from the container 300 but a film of the contact liquid remains disposed on the liquid-impregnated surface 1200.

The nucleation mechanism 2200 includes a nucleation member 2210 pivotally mounted in the internal volume of the container 300. For example, the nucleation member 2210 can be mounted on a pivot mount disposed on an internal side wall of the container 300, such that the nucleation member 2210 can swing about the pivot. The nucleation member 2210 can, for example, be shaped as a crescent. In some embodiments, the nucleation member 2210 can be shaped as a rectangular bar, a pendulum, a blade, or any other suitable shape. The nucleation member 2210 can include a sharp pointed tip 2212 and/or sharp edges, which can be configured to contact a contact liquid film disposed on the liquid-impregnated surface 1200 when the nucleation member 2210 is urged to swing about its pivot mount. The nucleation member 2210 is operatively coupled to a biasing member 2220 via a series of gears 2214. The biasing member 2220 can include, for example a spring (e.g., a helical spring, a coil spring, a compression spring, or a leaf spring) or any other suitable biasing member. The biasing member 2220 is disposed in a housing 2230. The housing 2230 is disposed on an outer surface of the side wall 310 of the container 300, for example, on a base of the container 300. The biasing member 2220 is mounted on a platform 2232, which is also disposed within the housing 2230. The gears 2214 are configured to transform a linear displacement of the biasing member 2220 into a rotary motion which urges the nucleation member 2210 to swing. In some embodiments, the gears 2214 can be disposed outside the internal volume defined by the container 300 and coupled to the nucleation member 2210 by a rigid coupling member, for example, a strut, a rod, a shaft or any other suitable coupling member. In such embodiments, a portion of the coupling member can be disposed in an orifice defined on a side wall of the container 300 such that the coupling member traverses the side wall of the container 300. Furthermore, gaskets, sealants, or any other sealing mechanism can be used to prevent communication of the contact liquid from the internal volume of the container 300 to the housing 2230.

To engage the nucleation member 2200, a user can apply a force on the platform 2232 as shown by the arrow F₂. At least a portion of the housing 2230 can be flexible or deformable to allow a user to engage the platform 2232, via a side wall of the housing 2230. In some embodiments, the housing 2130 can define a lumen such that the platform 2232 can slide within the lumen when engaged by a user. In some embodiments, the housing 2230 can define an opening on a bottom surface of the housing 2230 proximal to the platform 2232 configured to allow the user to engage the platform 2232 without needing to apply a force on the side wall of the housing 2230. The force F₂ can urge the biasing member 2220 into a second configuration, for example a compressed configuration as shown in FIG. 10, such that the biasing member 2220 urges the gears 2214 coupled thereto, to rotate as shown by the arrow B. The rotation further causes the nucleation member 2210 to swing as shown by the arrow C, such that tip 2212 of the nucleation member 2210 contacts and pierces the film of the contact liquid disposed on the liquid-impregnated film 1200. This creates a nucleation site in the contact liquid film causing it to destabilize and rapidly expel from the container 300. Once the user releases the force on the platform 2232, the biasing member 2220 can urge the nucleation member 2210 to return to the first configuration. Thus, the nucleation mechanism 2200 can be reused.

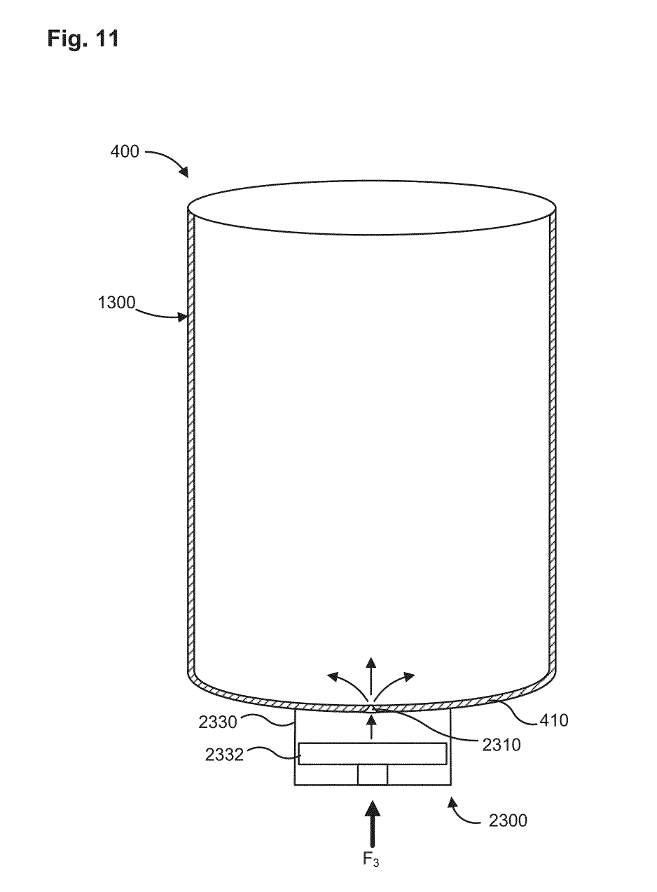

In some embodiments, air pressure can be used to destabilize a contact liquid CL film disposed on a liquid-impregnated surface. Referring now to FIGS. 11-13, a container 400 includes a liquid-impregnated surface 1300 and a nucleation mechanism 2300. A contact liquid can optionally be disposed in the internal volume defined by the container 400. The liquid-impregnated surface 1300 includes a surface, for example, an inner surface of a side wall 410 of the container 400, a plurality of solid features and an impregnating liquid. The impregnating liquid is impregnated into the interstitial regions defined by the plurality of solid features. The liquid-impregnated surface 1300 can be substantially similar to the liquid impregnated surface 100 described with respect to FIG. 1, and is therefore, not described in further detail herein. The liquid-impregnated surface 1300 can be in contact with the contact liquid, such that the contact liquid can easily displace over the liquid-impregnated surface 1300. The contact liquid can have a viscosity and/or surface tension such that when the contact liquid is evacuated from the container 400, a bulk of the contact liquid is evacuated rapidly from the container 400 but a film F of the contact liquid remains disposed on the liquid-impregnated surface 1300.

The nucleation mechanism 2300 includes an outlet 2310, for example a nozzle, an orifice, an aperture, a frit, a capillary tube, a valve, a slit, or any other suitably shaped opening, disposed on the side wall 410 of the container 400. In some embodiments, a plurality of outlets 2310 can be disposed on the side wall 410 of the container 400. A housing 2330 is disposed on an outer surface of the side wall 410. The housing 2330 defines an internal volume that contains a gas, for example air. The internal volume defined by the housing 2330 can be in fluid communication with the internal volume defined by the container 400 such that gas can flow from the internal volume of the housing 2330 to the internal volume of the container 400 or vice versa. The outlet 2310 can be configured to prevent contact liquid from flowing into the housing 2330. For example, the outlet 2310 can have a hydrophobic surface, have a small size, and/or include a valve. A plunger 2332 is disposed in the housing 2330. The plunger 2332 is configured to be engaged by a user to displace in a direction shown by the arrow F₃, such that the displacement expels the gas from the internal volume of the housing 2330 into the internal volume of the container 400. At least a portion of the housing 2330 can be flexible or deformable to allow a user to engage the plunger 2332, by applying the force F₃ on the side wall of the housing 2330.

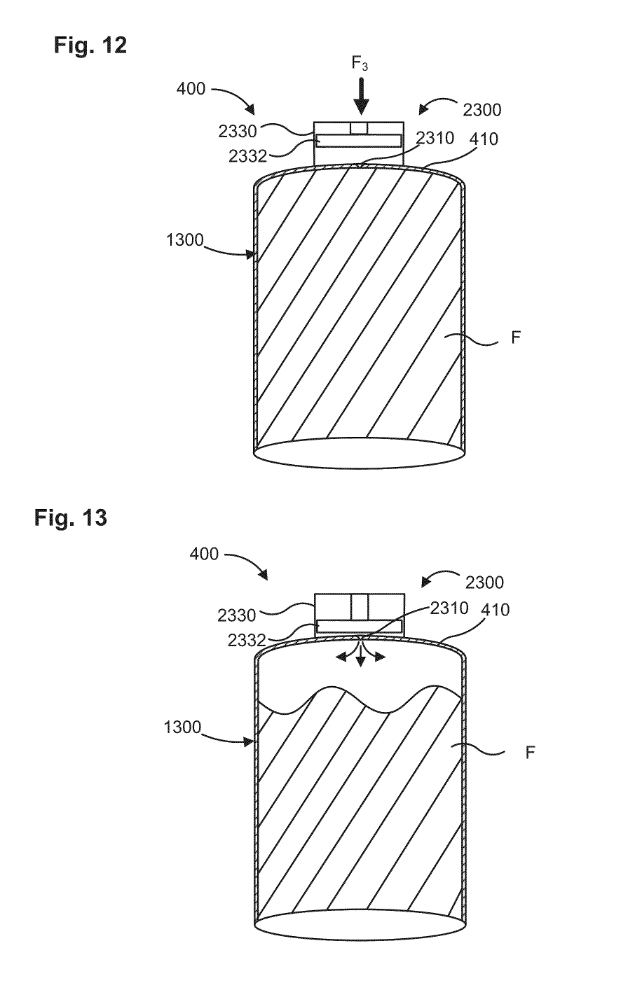

For example, as shown in FIG. 12, in a first configuration the container 400 can be oriented upside down such that a film F of the contact liquid is disposed on the liquid-impregnated surface 1300 and the plunger 2332 is not engaged by the user. The user can now engage the plunger 2332 to displace the plunger 2332 and urge the container 400 into a second configuration as shown in FIG. 13. The displacement of the plunger 2330 expels the gas disposed within the internal volume of the housing 2330 into the internal volume of the container 400. The expelled gas can create nucleation sites in the film F of the contact liquid, thereby destabilizing the film F and expelling it from the container 400.

In some embodiments, a biasing member, for example a spring (e.g., a helical spring, coil spring, leaf spring, etc.) can be included in the housing 2330 and configured to bias the plunger 2332 in the first configuration. The biasing member can prevent the inadvertent activation of the nucleation mechanism 2300, or to urge the plunger from the second configuration back into the first configuration. This can be advantageous when the container 400 is reused. For example, the container 400 can be a reusable plastic bottle, a glass jar, a can of paint, a drum of oil, laundry detergent cap, or a cough syrup, which is used as an intermediate container or a transfer container (e.g., a metering container), for housing the contact liquid for a short amount of time. In some embodiments, the biasing member can include a winding dial mechanism configured to pressurize the housing. The pressure in the housing can be released, for example, by opening a valve such that air rushes into the internal volume of the container 400 to nucleate and destabilize the film F.

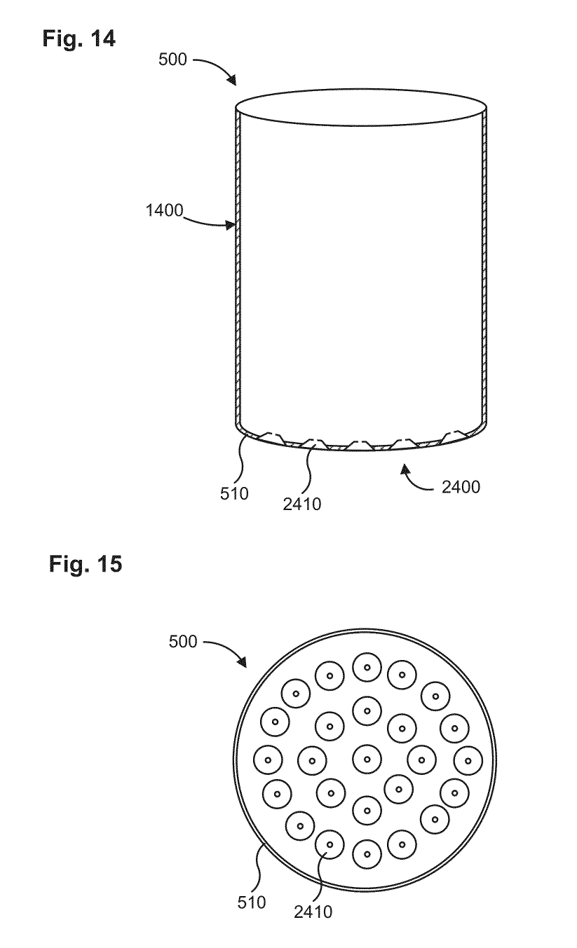

In some embodiments, a nucleation mechanism can include features to trap air, or any other gas (e.g., nitrogen or argon) which can be released as air bubbles to destabilize a contact liquid film. Referring now to FIGS. 14-16, a container 500 includes a liquid-impregnated surface 1400 and a nucleation mechanism 2400. A contact liquid CL can optionally be disposed in the internal volume defined by the container 500. The liquid-impregnated surface 1400 includes a surface, for example, an inner surface of a side wall 510 of the container 500, a plurality of solid features and an impregnating liquid. The impregnating liquid is impregnated into the interstitial regions defined by the plurality of solid features. The liquid-impregnated surface 1400 can be substantially similar to the liquid-impregnated surface 100 described with respect to FIG. 1, and is therefore, not described in further detail herein. The liquid-impregnated surface 1400 can be in contact with the contact liquid CL, such that the contact liquid CL can easily displace over the liquid-impregnated surface 1400. The contact liquid CL can have a viscosity and/or surface tension such that when the contact liquid CL is evacuated from the container 500, a bulk of the contact liquid CL is evacuated rapidly from the container 500 but a film of the contact liquid CL remains disposed on the liquid-impregnated surface 1400.

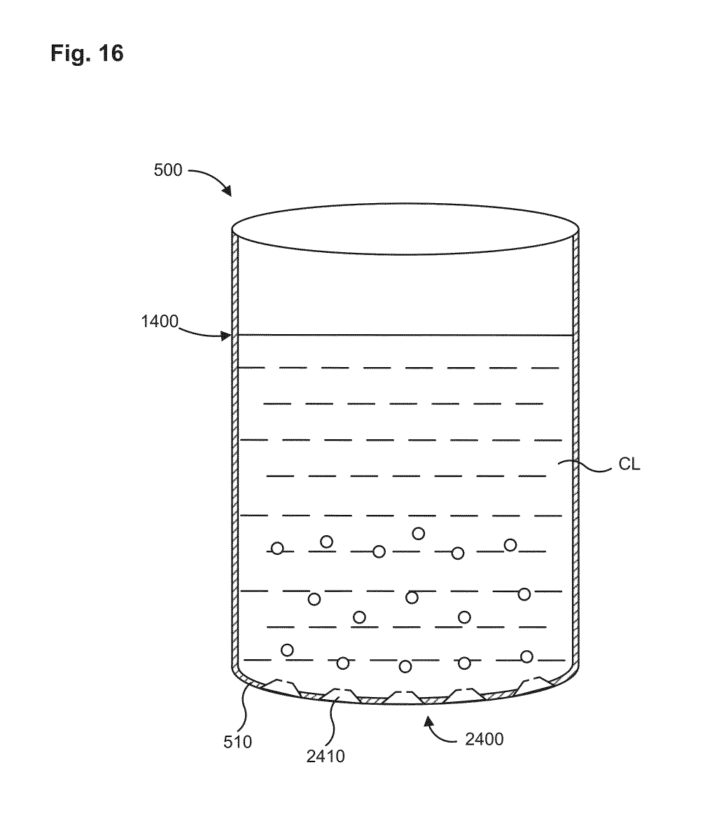

The nucleation mechanism 2400 includes one or a plurality of orifices 2410, for example holes, divots, spaces, or pits, disposed on the inner surface of the side wall 510 of the container 500. The orifices 2410 can be formed after the liquid-impregnated surface 1400 is disposed on the inner surface of the side wall 510. In some embodiments, the orifices 2410 can be formed on the inner surface of the side wall 510 using any suitable means, for example drilling (e.g., using a precise steel needle), roughening, or sand blasting. In some embodiments, the orifices 2410 can be formed separately and disposed on the inner surface of the side wall 510. Each of the orifices 2410 defines an internal volume configured to trap air. For example, when the internal volume of the container 500 is filled with the contact liquid CL, air can be trapped in the internal volume of each of the orifices 2410. The trapped air can periodically leak out from the orifices into the contact liquid CL as air bubbles (FIG. 16), which can create nucleation sites in the film of the contact liquid CL and destabilize the film. In some embodiments, a side wall of the plurality of orifices 2410 can be formed from an elastic material such that the side walls compress under hydrostatic pressure exerted by the bulk contact liquid CL disposed in the internal volume of the container 500. This hydrostatic pressure can urge the air trapped in the orifices 2410 to be expelled from the orifices 2410. In some embodiments, a reservoir of air can be disposed on an external side wall 510 of the container 500, which can be in fluid communication with the plurality of orifices 2410.

Any of the containers described herein, for example the container 100, 200, or any other container described herein, can include tubes, bottles, vials, flasks, molds, jars, tubs, cups, caps, glasses, pitchers, barrels, bins, totes, tanks, kegs, tubs, syringes, tins, pouches, lined boxes, hoses, cylinders, and cans. The containers can be constructed in almost any desirable shape. In some embodiments, any of the containers described herein can include hoses, piping, conduit, nozzles, syringe needles, dispensing tips, lids, pumps, and other surfaces for containing, transporting, or dispensing a contact liquid. The containers can be formed using any suitable material including plastic, glass, metal, coated fibers, and combinations thereof. Suitable surfaces can include, for example, polystyrene, nylon, polypropylene, natural and synthetic waxes, polyethylene terephthalate, polypropylene, polyethylene, polyurethane, polysulphone, polyethersulfone, polytetrafluoroethylene (PTFE), polytrifluoroethylene (PtrFE), polychlorotrifluoroethylene (PCTFE), polyvinyl alcohol (PVA), polyethyleneglycol (PEG), tetrafluoroethylene (TFE), fluorinated ethylenepropylene copolymer (FEP), polyvinylidene fluoride (PVDF), perfluoroalkoxytetrafluoroethylene copolymer (PFA), perfluoromethyl vinylether copolymer (MFA), ethylenechlorotrifluoroethylene copolymer (ECTFE), ethylene-tetrafluoroethylene copolymer (ETFE), Tecnoflon cellulose acetate, and polycarbonate. The containers can be constructed of rigid or flexible materials. Foil-lined or polymer-lined cardboard or paper boxes can also be used to form the containers.

While various embodiments of the system, methods and devices have been described above, it should be understood that they have been presented by way of example only, and not limitation. Where methods and steps described above indicate certain events occurring in certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An article comprising:
a liquid-impregnated surface, wherein said surface comprises a matrix of solid features spaced sufficiently close to stably contain an impregnating liquid therebetween and/or therewithin regardless of orientation of the article, wherein the article includes an impregnating liquid between and/or within the matrix of solid features, the article configured to contain a contact liquid different from the impregnating liquid, wherein the solid features have an average dimension in a range of up to 200 microns; and
a nucleation mechanism configured to nucleate and destabilize a film of the contact liquid that remains disposed on the liquid-impregnated surface after a bulk of the contact liquid has been displaced from the liquid-impregnated surface.

2. The article of claim 1, wherein the article is a container.

3. The article of claim 1, wherein the nucleation mechanism includes a nucleation member, the nucleation member configured to contact the film of the contact liquid thereby nucleating and destabilizing the film of the contact liquid.

4. The article of claim 3, wherein the nucleation member has a density less than a density of the contact liquid such that the nucleation member floats in a bulk of the contact liquid, the nucleation member coupled to an anchor disposed on an inner surface of a side wall of the article.

5. The article of claim 3, wherein the nucleation member includes at least one of a solid ball, a jack, a pyramid, a polygon, and a pendulum.

6. The article of claim 3, wherein the nucleation member is hollow.

7. The article of claim 3, wherein an outer surface of the nucleation member includes at least one of needles, jacks, sharp edges, and barbs disposed thereon.

8. The article of claim 1, wherein the nucleation mechanism includes a nucleation member and a biasing member, the biasing member configured to be engaged by a user and to move the nucleation member from a first configuration in which the nucleation member does not contact the film of the contact liquid, and into a second configuration in which the nucleation member contacts the film of the contact liquid, thereby nucleating and destabilizing the film of the contact liquid.

9. The article of claim 3, wherein the nucleation member is a hook, the hook including a plurality of barbs.

10. The article of claim 1, wherein the nucleation mechanism includes a nucleation member and a biasing member, the biasing member configured to:
urge the nucleation member to swing towards an inner surface of a side wall of the article and to contact the film of the contact liquid when engaged by a user; and
urge the nucleation member to swing away from the inner surface of the side wall when disengaged by the user.

11. The article of claim 1, wherein the nucleation mechanism includes:
an opening disposed on a side wall of the article; and
a reservoir of a gas disposed on an outer surface of a side wall of the article, the reservoir in fluidic communication, via an outlet, with an internal volume defined by the article, the reservoir further including a plunger, the plunger configured, when engaged by a user, to deliver a portion of the gas contained within the reservoir into the internal volume defined by the article such that the portion of the gas contacts the film of the contact liquid, thereby nucleating and destabilizing the film of the contact liquid.

12. The article of claim 1, wherein the nucleation mechanism defines one or more voids disposed on an inner surface of a side wall of the article, each of the one or more voids defining an interior volume configured to trap air, the nucleation mechanism configured such that, in use, air bubbles are released from the voids into the contact liquid and contact the film of the contact liquid thereby nucleating and destabilizing the film of the contact liquid.

13. The article of claim 12, wherein the one or more voids are monolithically formed with the container.

14. A liquid-destabilizing apparatus comprising:
a container including a substantially non-wetting surface, the surface having at least one of: a plurality of solid features and an impregnating liquid disposed thereon; and
a nucleation member including at least one of:
a nucleation object attached to an internal surface of the container by a tether;
a reciprocating plunger disposed within the container;
a pivotable rocker disposed within the container;
an orifice in a wall of the container, the orifice coupled to a chamber comprising a plunger, the chamber and plunger disposed outside of, but attached to, the container; and
a plurality of voids defined within an end wall of the container,
the nucleation mechanism configured, in use, to contact and destabilize a film of a contact liquid disposed on the non-wetting surface.

15. The apparatus of claim 14, wherein the nucleation member has a density less than a density of the contact liquid such that the nucleation member floats in a bulk of the contact liquid.

16. The apparatus of claim 14, wherein the nucleation member includes the nucleation object attached to the internal surface of the container by the tether, wherein an outer surface of the nucleation object comprises at least one of needles, jacks, sharp edges, and barbs.

17. The apparatus of claim 14, wherein the nucleation mechanism is configured, in use, to contact and destabilize the film of the contact liquid disposed on the non-wetting surface in response to a user action.

18. The apparatus of claim 14, wherein the nucleation member includes the reciprocating plunger disposed within the container, the reciprocating plunger comprising at least one of a hook and a barb.

19. The apparatus of claim 14, wherein the nucleation member includes the reciprocating plunger disposed within the container and a biasing element.

20. The apparatus of claim 14, wherein the nucleation member includes the pivotable rocker disposed within the container and a biasing element.

21. A method of manufacturing a liquid-destabilizing article, the method comprising:
providing a container including a plurality of walls defining an interior volume;
applying and/or forming a matrix of solid features on an interior surface of the container;
introducing an impregnating liquid into one or more interstitial regions defined by one or more spaces between the solid features of the matrix, such that the impregnating liquid is stably contained within the one or more interstitial regions regardless of orientation of the container; and
attaching at least one of:
a nucleation object and tether to an internal surface of the container;
a reciprocating plunger to an internal surface of the container;
a pivotable rocker to an internal surface of the container;
a chamber comprising a plunger to an external surface of the container; and
a plurality of void-defining structures to an interior surface of an end wall of the container.
